(19) United States
(12) Patent Application Publication
(10) Pub. No.: US 2008/0283352 A1
(43) Pub. Date: Nov. 20, 2008

(54) Electromagnetic actuator

(76) Inventor: Stephen H. Purvines, Mishawaka, IN (US)

Correspondence Address: BROOKS, CAMERON & HUEBSCH , PLLC, 1221 NICOLLET AVENUE , SUITE 500, MINNEAPOLIS, MN, 55403, US

(21) Appl. No.: 11/804,078

(22) Filed: May 17, 2007

(51) Int. Cl. F16D 27/02; H01H 9/02

(52) U.S. Cl. 192/84.1; 335/202

(57) ABSTRACT

Electromagnetic actuators, components of electromagnetic actuators, clutches that use electromagnetic actuators, and methods associated therewith for improved electromagnetic actuator operation and manufacturing methods. Embodiments of an electromagnetic actuator of the present disclosure includes a configuration of a housing and a flux washer relative a shaft helps to reduce the travel path for magnetic flux generated by an electrical coil contained therein. This more direct flux path, in turn, provides for a shorter loop for the magnetic flux, which helps to generate a greater relative magnetic force (e.g., a stronger clutch actuation force) as compared to other configurations.

Electromagnetic actuators transform electrical and mechanical energy into one another using the electromagnetic-mechanical principle. Electromagnetic actuators can be found in many products used in daily life. Examples include CD players, cameras, washing machines, heating and cooling systems, machining equipment, automobiles, boats, aircraft, and many medical devices.

Often times the output of an actuator is mechanical work. Examples of such actuators include those used in controlling fans and/or pumps in automobiles. The input to this type of actuator is electrical, where a magnetic flux is used to releasably engage and operate a mechanical component (e.g., a fan blade). It is desirable to minimize the amount of electrical power input and/or to minimize electrical power loss in electrically driving an actuator. To this end, there continues to be a need for actuator designs that can provide for greater efficiencies in both the mechanical and electrical requirements of operating an actuator.

### BRIEF DESCRIPTION OF THE DRAWINGS

The Figures presented herein provide illustrations of non-limiting example embodiments of the present disclosure. The Figures are not necessarily to scale.

FIG. 1 illustrates a cross-sectional view of one embodiment of an electromagnetic actuator assembly according to the present disclosure.

FIG. 2 illustrates a cross-sectional view of one embodiment of an electromagnetic actuator assembly used in a clutch assembly according to the present disclosure.

FIG. 3 illustrates one embodiment of a clutch assembly including an electromagnetic actuator assembly according to the present disclosure.

### DETAILED DESCRIPTION

Embodiments of the present disclosure include electromagnetic actuators, components of electromagnetic actuators, clutches that use electromagnetic actuators, and methods associated therewith for improved electromagnetic actuator operation and manufacturing methods. It will be apparent to those skilled in the art that the following description of the various embodiments of this disclosure are provided for illustration only and not for the purpose of limiting the disclosure as defined by the appended claims and their equivalents.

As will be described herein, embodiments of an electromagnetic actuator of the present disclosure includes an electrical coil for generating a magnetic flux, a rotary bearing positioned next to the electrical coil, a flux washer located between the rotary bearing and the electrical coil, a shaft mounted to the rotary bearing and positioned in the annular opening of the electrical coil and the hole of the flux washer, where the shaft rotates on the bearing in the annular opening and the hole. The electromagnetic actuator also includes a ring coupled to and extending radially from the shaft and a housing coupled to the ring, where the housing extends radially from the ring around at least a portion of the first end of the electrical coil to extend parallel with the outer surface of the electrical coil past the second end of the electrical coil and at least a portion of the second edge of the flux washer.

In the embodiments described in the present disclosure, the configuration of the housing and the flux washer relative the shaft helps to reduce the travel path for the magnetic flux generated by the electrical coil contained therein. In one embodiment, the travel path for the magnetic flux for the present disclosure is reduced relative to other configurations that provide a flux pathway. For example, the number of corners in the path of the magnetic flux for the present disclosure is reduced relative other configurations, thereby providing for a more direct flux path (e.g., smaller relative path) around the electrical coil. This more direct flux path, in turn, provides for a shorter loop for the magnetic flux helping to generate a greater relative magnetic force (e.g., a stronger clutch actuation force) as compared to other configurations, leading to greater electrical efficiency as compared to prior art actuators.

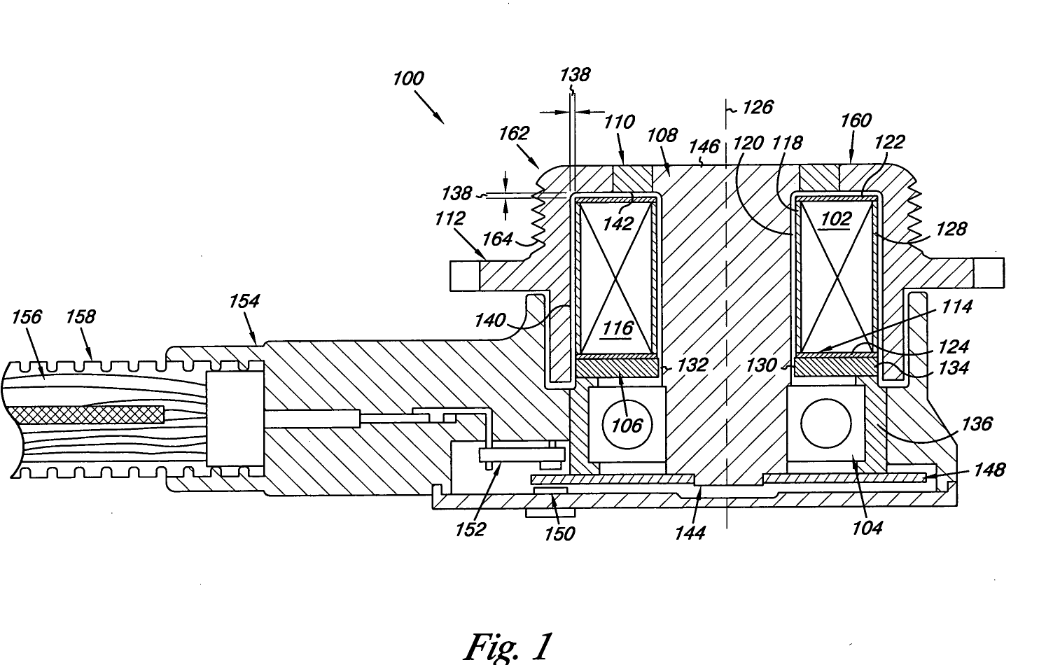

FIG. 1 provides a cross-sectional view of an embodiment of an electromagnetic actuator 100 according to the present disclosure. Embodiments of the electromagnetic actuator 100 of the present disclosure can be used with a fluid clutch of a motor vehicle, where the fluid clutch can be used to engage a cooling fan under the control of one or more sensors. Other embodiments are possible.

The electromagnetic actuator 100 includes an electrical coil 102, a rotary bearing 104, a flux washer 106, a shaft 108, a ring 110, and a housing 112. In one embodiment, the electrical coil 102 includes a bobbin 114 in which magnetic wire 116 is wound. As appreciated, the magnetic wire 116 is coupled to an electrical energy source so that a magnetic flux can be generated by the electrical coil 102.

The electrical coil 102 includes an inner surface 118 that defines an annular opening 120. The electrical coil 102 also includes a first end 122 and a second end 124, where the annular opening 120 extend between the first and second ends 122, 124 taken along a longitudinal axis 126 of the electrical coil 102. The electrical coil 102 also includes an outer surface 128 between the first end 122 and the second end 124.

In one embodiment, the flux washer 106 can be positioned adjacent and between the rotary bearing 104 and the second end 124 of the electrical coil 102. The flux washer 106 can be statically positioned relative the electrical coil 102. In other words, the flux washer 106 remains static and does not rotate relative the electrical coil 102. As illustrated, the flux washer 106 extends from a first edge 130 defining a hole 132 through the flux washer 106 to a second edge 134 adjacent the outer surface 128 of the electrical coil 102. In one embodiment, the second edge 134 and the outer surface 128 of the electrical coil 102 align in a common plane.

In an additional embodiment, the first and second edges 130, 134 of the flux washer 106 can extend past the respective inner surface 118 and outer surface 128 of the electrical coil 102. Alternatively, one or both of the first and/or second edges 130, 134 can align with the respective inner and/or outer surface 118, 128 of the electrical coil 102. In addition, one or both of the first and/or second edges 130, 134 can be positioned between the inner and/or outer surface 118, 128 of the electrical coil 102. Various combinations of these configurations are also possible.

As illustrated, the flux washer 106 can have a uniform thickness between the first and second edges 130, 134. Alternatively, the flux washer can have a thickness that varies either uniformly or non-uniformly between the two edges 130, 134. In addition, the flux washer 106 can be formed from a ferromagnetic material to guide a magnetic flux. Examples of such materials include, but are not limited to; low carbon cold rolled steel, low carbon free machining steel, 400 series stainless steel, and/or soft magnetic iron composite. Other types of magnetic materials are also possible.

In an alternative embodiment, the flux washer 106 can be formed from two or more layers of materials, one of which is the ferromagnetic material. For example, the flux washer 106 could have a multilayer construction that includes at least one layer that extends from the first edge 130 to the second edge 134 formed of the ferromagnetic material. Other layers used in forming the multilayer construction can include a non-ferromagnetic material such as a non-magnetic stainless steel.

In an additional embodiment, the flux washer 106 can have a planar configuration. In other words, the flux washer 106 can be flat. Alternatively, the flux washer 106 could have a convex or a concave configuration. Other shapes are possible.

The rotary bearing 104 is illustrated being mounted between a bearing spacer 136 on the electromagnetic actuator 100 and the shaft 108, where the shaft 108 is mounted to and supported by the bearing 104. The rotary bearing 104 can support and guide the shaft 108 while it rotates in the annular opening 120 of the electrical coil 102 and the hole 132 of the flux washer 106. As illustrated, the rotary bearing 104 is positioned adjacent the second end 124 of the electrical coil 102 with the flux washer 106, as discussed herein, positioned between the rotary bearing 104 and the second end 124 of the electrical coil 102.

The electromagnetic actuator 100 further includes the ring 110 that is coupled to and extends radially from the shaft 108. In one embodiment, the ring 110 has an annular configuration that separates the shaft 108 from the housing 112. In one embodiment, the ring 110 can be formed from a non-magnetic material that diverts the magnetic flux generated by the electrical coil 102. Examples of such materials include, but are not limited to, 300 series stainless steel, brass, copper, and/or aluminum. Other types of non-magnetic materials are also possible.

In the present embodiment, the housing 112 is coupled to the ring 110. As illustrated, the housing 112 extends radially from the ring 110 along and around at least a portion of the first end 122 of the electrical coil 102. In one embodiment, the ring 110 and the housing 112 maintain a predetermined distance 138 from the electrical coil 102. For example, the housing 112 can include a first surface 140 that is spaced apart for the outer surface of the electrical coil 102 by the predetermined distance 138. Similarly, the ring 110 includes an inner surface 142 (aligned with first surface 140) that is also spaced apart for the outer surface of the electrical coil 102 by the predetermined distance 138. In one embodiment, this allows the housing 112 and ring 110 to be at a uniform distance from the first end 122 of the electrical coil 102.

As illustrated, the first surface 140 of the housing 112 extends longitudinally adjacent the electrical coil 102, where the first surface 140 maintains a uniform distance from the shaft 108 and the predetermined distance 138 from the electrical coil 102. In one embodiment, the first surface 140 extends at least the complete length of the annular opening 120 of the coil 102 and the hole 132 of the flux washer 106.

As illustrated, the housing 112 is outside both the electrical coil 102 and the bearing 104. The first surface 140 of the housing 112 extends parallel with the outer surface 128 of the electrical coil 102 past the second end 124 of the electrical coil 102 and at least a portion of the second edge 134 of the flux washer 106. In other words, the first surface 140 of the housing 112 extends at least the complete length of the annular opening 120 and the hole 132 of the flux washer. In one embodiment, the first surface 140 of the housing 112 extends past both the outer surface 128 of the electrical coil 102 and the second edge 134 of the flux washer 106.

The shaft 108 includes a first end 144 and a second end 146. As illustrated, the shaft 108 can be rotatably mounted to the rotary bearing 104 between the first and second ends 144, 146. Other configurations are possible (e.g., bearing 104 at the first end 144). In one embodiment, the shaft 108 can be coupled to a tone wheel 148 at the first end 144, where the tone wheel 148 interacts with a magnet 150 and sense/control electronics 152 to sense rotation of the shaft 108. In the present embodiment, the housing 112, the ring 110, and the shaft 108 rotate together relative the flux washer 106.

The electromagnetic actuator 100 can also include an overmolded body 154, lead wires 156, and wire cover 158, among other structures of the electromagnetic actuator 100. In one embodiment, the overmolded body 154 can be formed from a molding process using, by way of illustration and not by limitation, thermoplastic and thermoset polymers. Examples of such molding processes can include resin transfer molding, compression molding, transfer molding, and injection molding, among others.

Examples of thermoplastic polymers include polyolefins such as polyethylene and polypropylene, polyesters such as Dacron, polyethylene terephthalate and polybutylene terephthalate, vinyl halide polymers such as polyvinyl chloride (PVC), polyvinylacetate such as ethyl vinyl acetate (EVA), polyurethanes, polymethylmethacrylate, pellethane, polyamides such as nylon 4, nylon 6, nylon 66, nylon 610, nylon 11, nylon 12 and polycaprolactam, polyaramids (e.g., KEVLAR), segmented poly(carbonate-urethane), Rayon, fluoropolymers such as polytetrafluoroethylene (PTFE or TFE) or expanded polytetrafluoroethylene (ePTFE), ethylene-chlorofluoroethylene (ECTFE), fluorinated ethylene propylene (FEP), polychlorotrifluoroethylene (PCTFE), polyvinylfluoride (PVF), or polyvinylidenefluoride (PVDF).

As used herein, a thermoset material includes those polymeric materials that once shaped by heat and pressure so as to form a cross-linked polymeric matrix are incapable of being reprocessed by further application of heat and pressure. As provided herein, thermoset materials can be formed from the polymerization and cross-linking of a thermoset precursor. Such thermoset precursors can include one or more liquid resin thermoset precursors. In the embodiments described herein, the liquid resin thermoset precursor can be selected from an unsaturated polyester, a polyurethane, an epoxy, an epoxy vinyl ester, a phenolic, a silicone, an alkyd, an allylic, a vinyl ester, a furan, a polyimide, a cyanate ester, a bismaleimide, a polybutadiene, and a polyetheramide. As will be appreciated, the thermoset precursor can be formed into the thermoset material by a polymerization reaction initiated by heat, pressure, catalysts, and/or ultraviolet light.

As will be appreciated, the thermoset material used in the embodiments of the present disclosure can include non-electrically conducting reinforcement materials and/or additives such as non-electrically conductive fillers, fibers, curing agents, inhibitors, catalysts, and toughening agents (e.g., elastomers), among others, to achieve a desirable combination of physical, mechanical, and/or thermal properties.

Non-electrically conductive reinforcement materials can include woven and/or nonwoven fibrous materials, particulate materials, and high strength dielectric materials. Examples of non-electrically conductive reinforcement materials can include, but are not limited to, glass fibers, including glass fiber variants, synthetic fibers, natural fibers, and ceramic fibers.

Non-electrically conductive fillers include materials added to the matrix of the thermoset material to alter its physical, mechanical, thermal, or electrical properties. Such fillers can include, but are not limited to, non-electrically conductive organic and inorganic materials, clays, silicates, mica, talcs, asbestos, rubbers, fines, and paper, among others.

In an additional embodiment, the liquid resin thermoset precursor can include a polymerizable material sold under the trade designator “Luxolene” from the Kurz-Kasch Company of Dayton Ohio.

The housing 112 further includes a second surface 160 that includes a fastening structure 162. In one embodiment, the fastening structure 162 can be the second surface 160 of the housing 112 configured as threads 164. In one embodiment, the fastening structure 162 can be used to couple the electromagnetic actuator 100 to a clutch.

As discussed herein, many modern vehicles include an engine and an electromagnetic actuator for controlling a viscous fluid clutch associated with an engine cooling fan. In general operation, the clutch is designed to couple and decouple the fan and the engine. When the clutch is actuated, a rotary force is transmitted from the engine through the clutch to the fan. In this manner, the cooling fan is mechanically driven by the engine. Typically, the rotary force is produced by a water pump pulley within the engine. When the clutch is deactuated, the fan is decoupled from the engine. As such, no rotary force is transmitted from the engine to the fan. The electromagnetic actuator is used to actuate and deactuate the clutch.

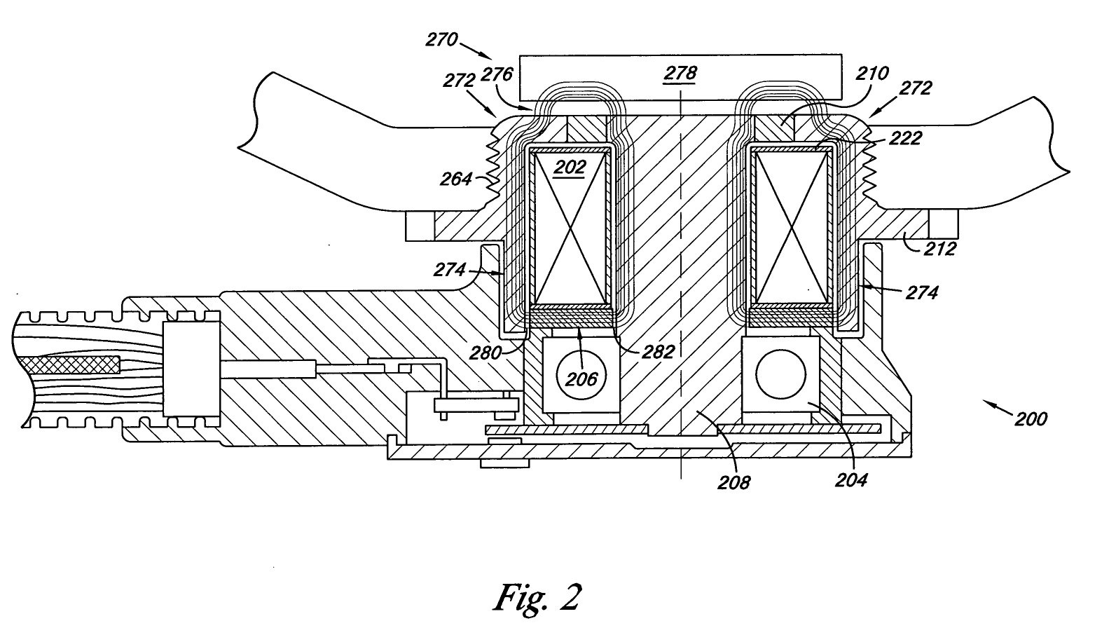

FIG. 2 provides a cross-sectional view of a clutch 270 that includes the electromagnetic actuator 200 of the present disclosure. As illustrated, the clutch 270 includes a clutch mount 272 to which the actuator 200 can be mounted. In one embodiment, the actuator 200 is mounted to the clutch mount 272 using the threads 264 on the outer surface of the housing 212. Other ways of coupling the actuator 200 to the clutch 270 are possible.

As illustrated, the electrical coil 202 encircles the shaft 208. When electrical current is applied to the actuator 200, the coil 202 receives the current to produce magnetic flux 274. The magnetic flux 274 then flows in a loop that radially encircles the coil 202. The magnetic flux 274 consists of magnetic lines of force which collectively constitute a magnetic field. The magnetic field is formed in a toroidal or doughnut like shape along the axis of the shaft 208.

In one embodiment, the housing 212 and the shaft 208 form part of a flux path to direct and guide the magnetic flux 274 produced by the electrical coil 202. As illustrated, the flux path for both the housing 212 and the shaft 208 are essentially uniform relative each other. In other words, the housing 212 and the shaft 208 provide for the most direct flux pathway (i.e., essentially straight) between the flux washer 206 and the first end 222 of the coil 202. For example, the magnetic flux 274 travels in parallel paths through the shaft 208 and the housing 212 along an entire length of the electrical coil 202.

In some embodiments, the non-magnetic nature of the ring 210 can prevent the magnetic flux 274 from flowing directly between shaft 208 and the housing 212. In one embodiment, the ring 210 can cause the magnetic flux 274 to deflect radially from the coil 202 to cross gap 276 between the actuator 200 and a spring-loaded armature plate 278 located inside the clutch 270. In the illustrated embodiment, the spring-loaded armature plate 278 is shown in an inactive state positioned adjacent an interface surface of the shaft 208, the ring 210 and the housing 212 to form the gap 276.

When electrical current is applied to the actuator 200, the magnetic flux 274 applies a magnetic force across the gap 276 to pull the armature plate 278 into contact with the shaft 208, the ring 210, and/or the housing 212. In this active state, the gap 276 is reduced as the armature plate 278 makes contact with the actuator 200. Once in contact, the armature plate 278 causes the transfer of mechanical/fluid motion through the use of the magnetic flux 274. In this manner, the actuator 200 actuates the clutch 270.

As illustrated, the magnetic flux 274 travels in a path that is in close proximity to the electrical coil 202. For example, the magnetic flux 274 extends from the first end 222 of the shaft 208 through the length of the shaft 208 to the second end 224 of the shaft 208. The flux 274 is then directed through a first air gap 280 between the housing 212 and the flux washer 206. The flux 274 passes through the flux washer 206 and through a second air gap 282 between the shaft 208 and the flux washer 206.

The magnetic flux 274 then travels along the housing 212 in parallel to the flux 274 in the shaft 208. The flux 274 then passes from the housing 212 to the armature plate 278 and then back to the shaft 208 around the ring 210. Embodiments of the flux path for the present disclosure are relatively short as compared to alternative approaches. For example, the flux path provided by the housing 212, the shaft 208, the flux washer 206, and the ring 210 maintains a very close and uniform distance from the coil 202. As a result, the present embodiments provide for a flux path that is very short, if not as short as possible, as compared to other electromagnetic actuator designs. Because of this shorter flux path, the strength of the clutch actuation force and overall electrical efficiency of the actuator 200 is improved as compared to other approaches.

When power is not applied to the actuator 200, the armature plate 278 returns to the spring-loaded inactive position. In the spring-loaded inactive position, the armature plate 278 restricts fluid flow and coupling within the clutch 270. In this manner, the clutch 270 is deactuated.

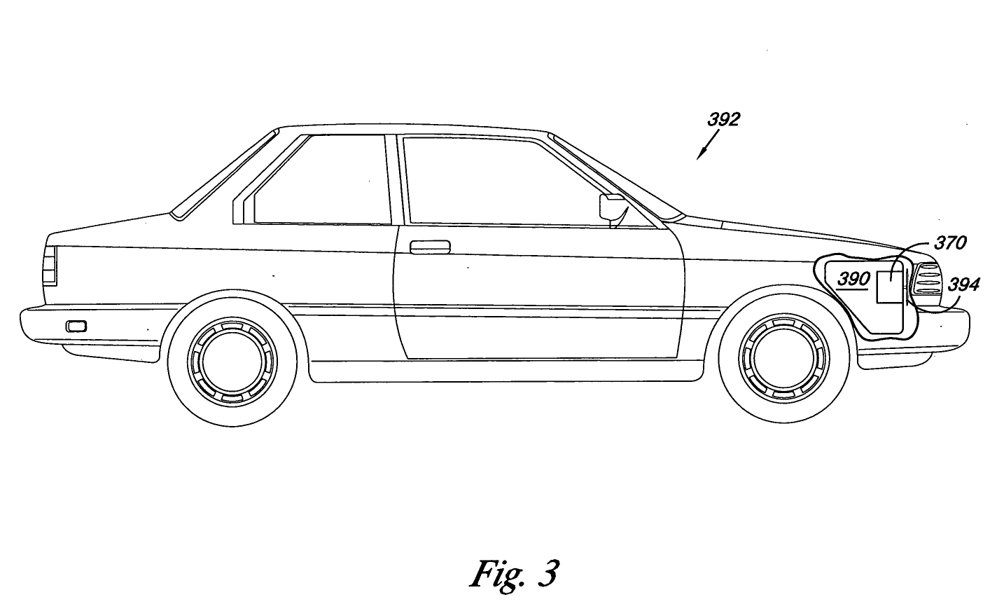

FIG. 3 provides an embodiment in which the clutch 370 of the present disclosure is mounted in an engine 390 of an automobile 392. As illustrated, the clutch 370 is coupled to an engine cooling fan 394, where the actuator of the present disclosure can be used to couple and decouple the cooling fan 394 of the engine 390. When the clutch 370 is actuated, a rotary force is transmitted from the engine 390 through the clutch 370 to the fan 394.

While the present disclosure has been shown and described in detail above, it will be clear to the person skilled in the art that changes and modifications may be made without departing from the spirit and scope of the disclosure. As such, that which is set forth in the foregoing description and accompanying drawings is offered by way of illustration only and not as a limitation. The actual scope of the disclosure is intended to be defined by the following claims, along with the full range of equivalents to which such claims are entitled.

In addition, one of ordinary skill in the art will appreciate upon reading and understanding this disclosure that other variations for the disclosure described herein can be included within the scope of the present disclosure.

What is claimed is:

1. A electromagnetic actuator, comprising:
an electrical coil having a first end and a second end, an inner surface that defines an annular opening between the first end and the second end, and an outer surface between the first end and the second end;
a rotary bearing adjacent the second end of the electrical coil;
a flux washer between the rotary bearing and the second end of the electrical coil, where the flux washer extends from a first edge defining a hole to a second edge adjacent the outer surface of the electrical coil;
a shaft mounted to the rotary bearing and positioned in the annular opening of the electrical coil and the hole of the flux washer, where the shaft rotates on the bearing in the annular opening and the hole;
a ring coupled to and extending radially from the shaft; and
a housing coupled to the ring, where the housing extends radially from the ring around at least a portion of the first end to extend parallel with the outer surface of the electrical coil past the second end of the annular magnetic coil and at least a portion of the second edge of the flux washer.

2. The electromagnetic actuator of claim 1, where the first edge of the flux washer extends past the inner edge of the electrical coil.

3. The electromagnetic actuator of claim 1, where the flux washer remains static relative the electrical coil.

4. The electromagnetic actuator of claim 1, where the flux washer is flat.

5. The electromagnetic actuator of claim 1, where the flux washer has a uniform thickness.

6. The electromagnetic actuator of claim 1, where the housing extends past both the outer surface of the electrical coil and the second edge of the flux washer.

7. The electromagnetic actuator of claim 1, where the housing includes a first surface that extends longitudinally adjacent the electrical coil, where the first surface maintains a uniform distance from the shaft.

8. The electromagnetic actuator of claim 1, where the housing and the flux washer are formed from a ferromagnetic material to guide a magnetic flux and the ring is formed from a non-magnetic material that diverts the magnetic flux.

9. A clutch, comprising:
an electromagnetic actuator, including:
an electrical coil having an inner surface that defines an annular opening;
a rotary bearing adjacent the electrical coil;
a flux washer having a first edge defining a hole, the flux washer statically positioned between the rotary bearing and the electrical coil;
a shaft supported by the rotary bearing, where the shaft rotates in the annular opening of the magnetic coil and the hole of the flux washer;
a ring coupled to and extending radially from the shaft; and
a housing having an inner surface, where the housing is coupled to the ring and the inner surface is positioned at a uniform distance from the electrical coil, where the inner surface extends at least a complete length of the annular opening and the hole of the flux washer; and
an armature plate that releasably couples to the shaft of the electromagnetic actuator.

10. The clutch of claim 9, where the housing includes an outer surface that defines threads to engage a clutch housing.

11. The clutch of claim 9, where the housing of the electromagnetic actuator rotates relative the flux washer.

12. The clutch of claim 9, where the housing and the shaft form a flux path to guide magnetic flux produced by the electrical coil, the flux path for both the housing and the shaft being essentially uniform.

13. The clutch of claim 9, where the electromagnetic actuator includes a first air gap between the housing and the flux washer and a second air gap between the shaft and the flux washer.

14. The clutch of claim 9, where the housing extends past both the electrical coil and the flux washer.

15. A method, comprising:
producing a magnetic flux with an electrical coil;
directing the magnetic flux through a shaft and a housing of an electromagnetic actuator, where the magnetic flux travels in parallel paths through the shaft and the housing along an entire length of the electrical coil; and
directing the magnetic flux from the shaft and the housing through a first air gap and a second air gap on either side of a flux washer.

16. The method of claim 15, including statically positioning the flux washer between a rotary bearing and the electrical coil.

17. The method of claim 15, including mounting the housing to a clutch.

18. The method of claim 15, including extending the housing past the electrical coil and the flux washer.

19. The method of claim 15, including physically coupling the housing to the shaft.

20. The method of claim 15, including positioning a non-magnetic ring between the housing and the shaft.
